(19) United States
(12) Patent Application Publication
(10) Pub. No.: US 2008/0150910 A1
(43) Pub. Date: Jun. 26, 2008

(54) Handwritten charater input device

(75) Inventor: Daisuke Nakajima, Fussa-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/002,890

(22) Filed: Dec. 19, 2007

(30) Foreign Application Priority Data
Dec. 25, 2006 (JP) 2006-348228

(51) Int. Cl. G06F 3/041

(52) U.S. Cl. 345/173

(57) ABSTRACT

A handwriting input section, which has a touch position sensing unit and a display unit integrated with each other in it, character-recognizes a handwritten character and causes a display section to display the recognized character as an input character. When the user specifies an input character to be corrected by touching the character in the input character string displayed on the display section at the handwriting input section, another recognized candidate character obtained by the character recognition for the specified input character to be corrected is displayed on the handwriting input section. According to the operation of the user touching the candidate character displayed on the handwriting input section, the input character to be corrected displayed on the display section is replaced with the touched candidate character.

### CROSS-REFERENCE TO RELATED APPLICATIONS

This application is based upon and claims the benefit of priority from prior Japanese Patent Application No. 2006-348228, filed Dec. 25, 2006, the entire contents of which are incorporated herein by reference.

### BACKGROUND OF THE INVENTION

1. Field of the Invention

This invention relates to a handwritten character input device which includes a handwriting input unit and a display unit for displaying a recognized character of a handwritten character input via the handwriting input unit.

2. Description of the Related Art

A handwritten character input device has been put to practical use. The handwritten character input device includes a character input unit to which the user inputs the desired characters by directly using the character keys on the keyboard as on the word processor, or a touch panel handwriting input unit. The handwritten character input at the handwriting input unit is character-recognized and the recognized character is input to the handwritten character input device.

Moreover, an electronic dictionary device capable of using a key input character string as a keyword (search character string) to retrieve its semantic content and displaying the retrieved data has been put to practical use.

Furthermore, Jpn. Pat. Appln. KOKAI Publication No. 2005-165533 has disclosed an electronic dictionary device with a handwriting input function which includes not only a key input unit (keyboard) for inputting a keyword (search character string) for searching the dictionary but also a handwriting input unit and which enables the user to write kanji characters or the like the user cannot read on the handwriting input unit, recognizes the characters, inputs the characters as the keyword (search character string), and displays the dictionary search.

In the conventional electronic dictionary device with a handwriting input function, although kanji characters or the like the user cannot read can be input, character-recognized, and displayed as a keyword (search character string), when the once-recognized handwritten characters displayed on the display unit need to be corrected, a complex operation which is a combination of a key input operation and a handwriting input operation has to be carried out, which is troublesome.

It is, accordingly, an object of the invention to provide a handwritten character input device capable of correcting the once-recognized handwritten characters displayed on the display unit if they need to be corrected, by a handwriting input operation without the need for a key input operation.

### BRIEF SUMMARY OF THE INVENTION

According to an aspect of the invention, there is provided a handwritten character input device comprising: a display section; a handwriting input section in which a touch position sensing unit and a display unit are integrated with each other; character recognizing means for character-recognizing a character written on the handwriting input section; recognized character display means for displaying as an input character a recognized character obtained at the character recognizing means; correction character specifying means for specifying an input character to be corrected in an input character string displayed on the display section by the recognized character display means according to a touch operation performed by the user at the handwriting input section; candidate character display means for displaying on the handwriting input section another recognized candidate character obtained at the character recognizing means for the input character to be corrected specified by the correction character specifying means; and character correcting means for replacing the input character to be corrected displayed on the display section with the touched candidate character according to the operation of the user touching the candidate character displayed on the handwriting input section by the candidate character display means.

With the invention, it is possible to provide a handwritten character input device capable of correcting the once-recognized handwritten characters displayed on the display unit if they need to be corrected, by a handwriting input operation without the need for a key input operation.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a front view showing an outward configuration of an electronic dictionary device with a handwriting input function according to an embodiment of a handwritten character input device of the invention;

FIG. 2 is a block diagram showing the configuration of the electronic circuit of the electronic dictionary device 10 with a handwriting input function;

FIG. 3 is a flowchart to help explain the dictionary search process of the electronic dictionary device 10 with a handwriting input function;

FIG. 4 is a flowchart to help explain a handwriting input process involved in the dictionary search process of the electronic dictionary device 10;

FIG. 5 is a drawing to help explain a dictionary search display operation (part 1) involved in the dictionary search process of the electronic dictionary device 10;

FIG. 6 is a drawing to help explain a dictionary search display operation (part 2) involved in the dictionary search process of the electronic dictionary device 10;

FIG. 7 is a flowchart to help explain a second handwriting input process in the handwriting input process involved in the dictionary search process of the electronic dictionary device 10; and

FIG. 8 is a drawing to help explain a handwriting input display operation in the handwriting input process involved in the dictionary search process of the electronic dictionary device 10.

### DETAILED DESCRIPTION OF THE INVENTION

Hereinafter, referring to the accompanying drawings, an embodiment of the invention will be explained.

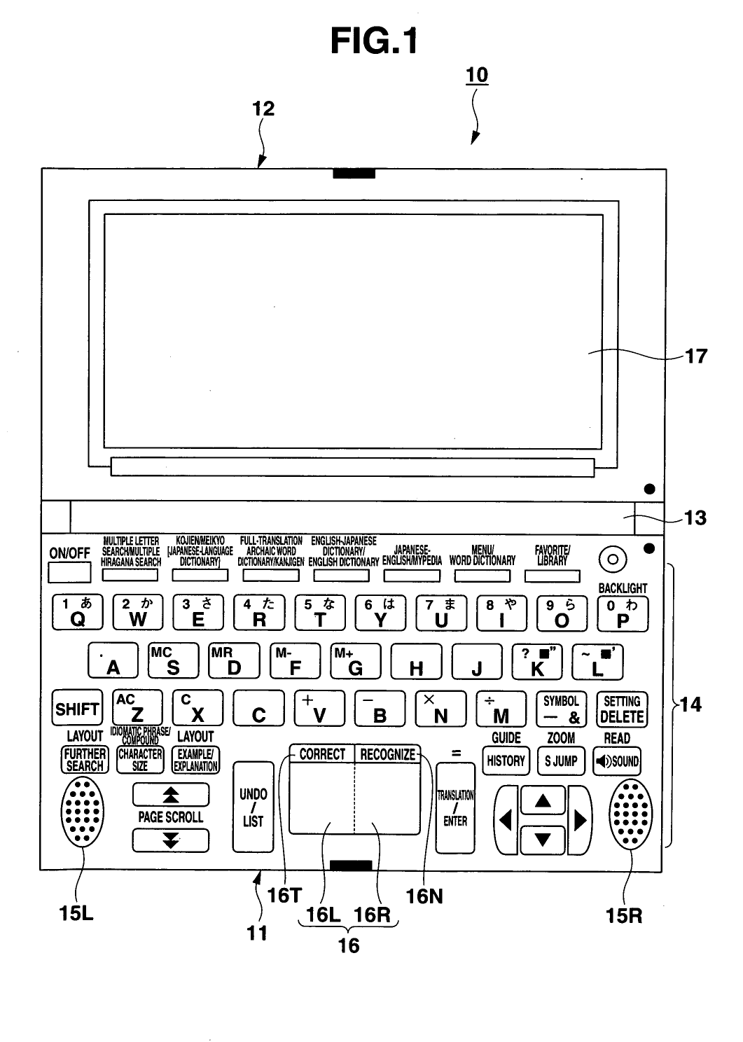

FIG. 1 is a front view showing an outward configuration of an electronic dictionary device 10 according to an embodiment of a handwritten character input device of the invention.

The electronic dictionary device 10 is so configured that a body case 11 and a cover case 12 are coupled with each other via a hinge section 13, thereby forming an openable and closable folding case. On the front face of the body case 11, there are provided a key input section 14 which includes a power key, various character and symbol keys, a dictionary specify key, a translate/decide key, a delete key, a cursor key, and others, speakers 15L, 15R, and a handwriting input section 16.

The handwriting input section 16 has a structure where a touch position sensing unit for sensing the position at which the user has touched with a pen, his or her finger, or the like is integral with a display unit. For example, the handwriting input section 16 is so configured that a transparent tablet unit is laid on a 128×64 dot liquid-crystal display screen on the center front side of the key input section 14.

The input area of the handwriting input section 16 has handwriting areas 16L, 16R for two characters. At the upper hem of the input area of the handwriting input section 16, the characters “Recognize” and “Correct” are printed on the tablet surface. The individual printed parts function as a “Recognize” button 16N for the user to specify a character recognition process and as a “Correct” button 16T for the user to correct or delete the recognized characters.

The writing strokes made on the handwriting areas 16L, 16R of the handwriting input section 16 are echoed back onto the liquid-crystal screen, which displays the strokes.

On the front face of the cover case 12, there is provided a display section (for example, a 480×320 dot-matrix liquid-crystal display screen with backlight) 17 on almost all the front face of the cover case 12.

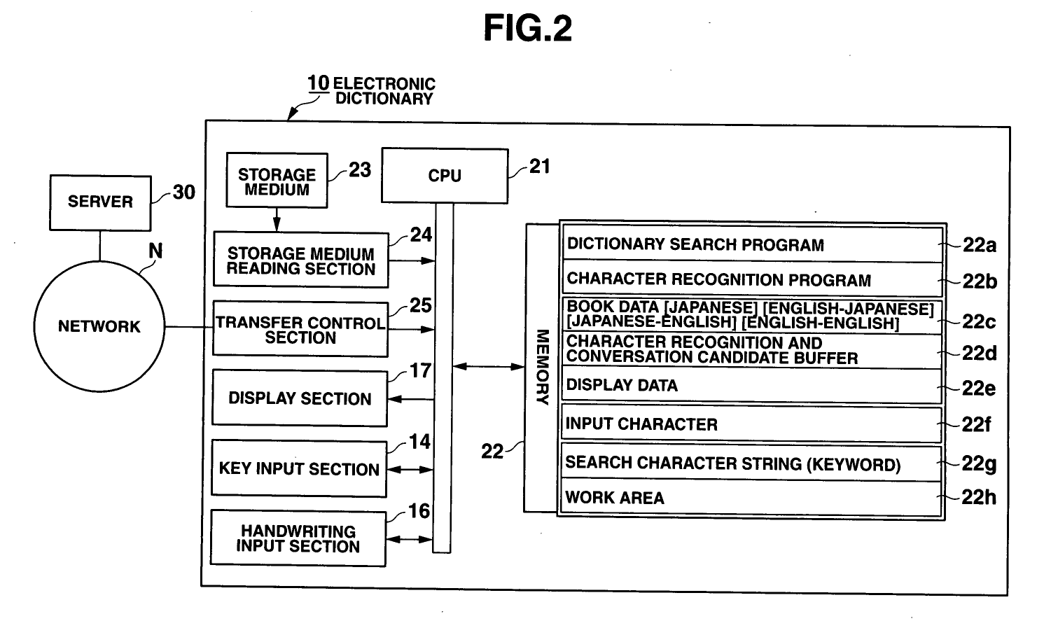

FIG. 2 is a block diagram showing the configuration of the electronic circuit of the electronic dictionary device 10.

The electronic dictionary device 10 is composed of a computer controlled by a program. The electronic circuit of the electronic dictionary device 10 includes a central processing unit (CPU) 21.

Connected to the CPU 21 are not only a memory 22, a storage medium reading section 24, a transfer control section 25, the key input section 14, and the handwriting input section 16 but also the display section 17, and others.

The memory 22 stores not only a system program which supervises the overall operation of the electronic dictionary device 10 and a communication program for data communication with each Web server 30 and a user personal computer (PC) on the Internet N via the transfer control section 25 but also a dictionary search program 22a for controlling the overall search process on the basis of dictionary data (22c) and a character recognition program 22b for recognizing handwritten characters displayed on the handwriting input section 16.

These programs may be stored in the memory 22 in advance or be read into the memory 22 from an external storage medium 23, such as a ROM card, via the storage medium reading section 24. Alternatively, these programs may be read into the memory 22 from a Web server (in this case, a program server) 30 on the Internet N via the transfer control section (communication section) 25.

Moreover, in the memory 22, there are provided a dictionary data memory 22c, a character recognition and conversion candidate buffer 22d, a display data memory 22e, an input character memory 22f, a search character string (keyword) memory 22g, a work area 22h, and others.

Different types of dictionary data, including a Japanese-language dictionary, an English-Japanese dictionary, a Japanese-English dictionary, an English-English dictionary, an English thesaurus, are stored in advance or downloaded into the dictionary data memory 22c.

When the handwritten characters input at the handwriting input section 16 are subjected to a character recognition process according to the character recognition program 22b, for example, a first to a tenth one of the recognized and converted candidate characters are stored in the character recognition and conversion candidate buffer 22d.

The display data memory 22e has a storage area for display data corresponding to the display screen of the display section 17 and a storage area for display data corresponding to the display screen of the handwriting input section 16. The data to be displayed on each of the display screens is stored in the display data memory 22e in the form of bitmap pattern data.

The input character memory 22f stores input data, including numbers, characters, and symbols input by the user at the key input section 14 or handwriting input section 16, according to the dictionary search program 22a.

The search character string (keyword) memory 22g stores a character or a character string input or specified as the object of a dictionary search process.

The work area 22h stores various items of data input to and output from the CPU 21 according to various device control programs, including the dictionary search program 22a and character recognition program 22b, as needed.

Next, the operation of the electronic dictionary device 10 will be explained.

Explanation will be given mainly about the operation in a case where the dictionary is searched using the Japanese-language dictionary, with the character (character string) input at the handwriting input section 16 as a search character string (keyword). Since the operation in a case where the dictionary is searched, with the character (character string) input at the key input section 14 as a search character string (keyword), is the same as an ordinary operation, its explanation will be omitted.

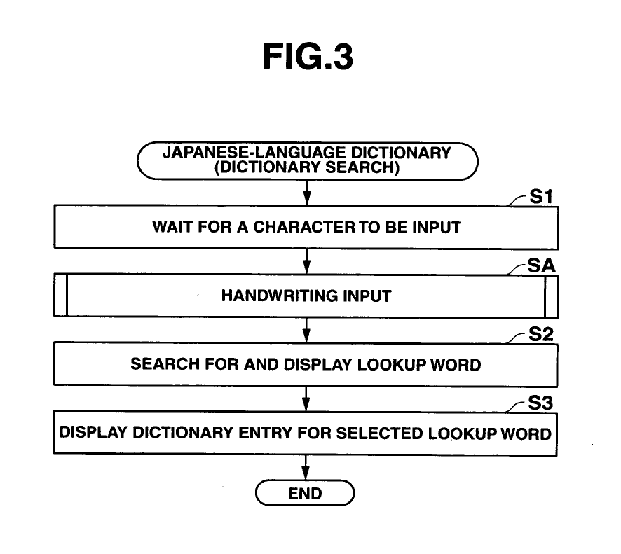

FIG. 3 is a flowchart to help explain the dictionary search process of the electronic dictionary device 10.

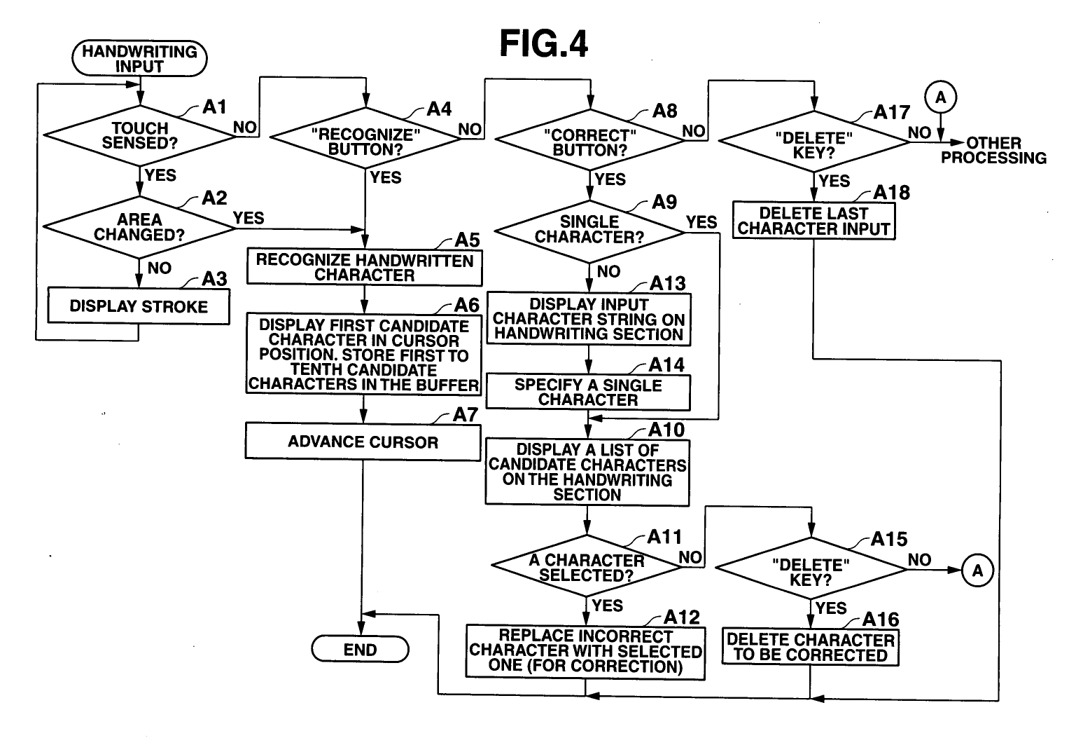

FIG. 4 is a flowchart to help explain the handwriting input process involved in the dictionary search process of the electronic dictionary device 10.

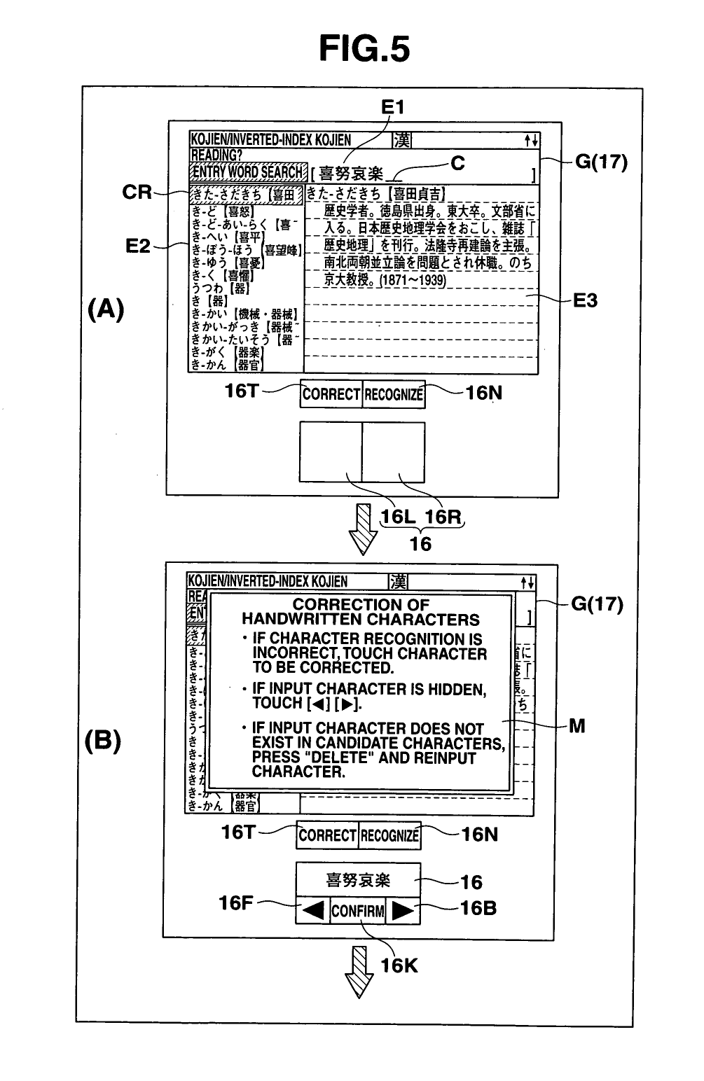

FIG. 5 is a drawing to help explain the dictionary search display operation (part 1) involved in the dictionary search process of the electronic dictionary device 10.

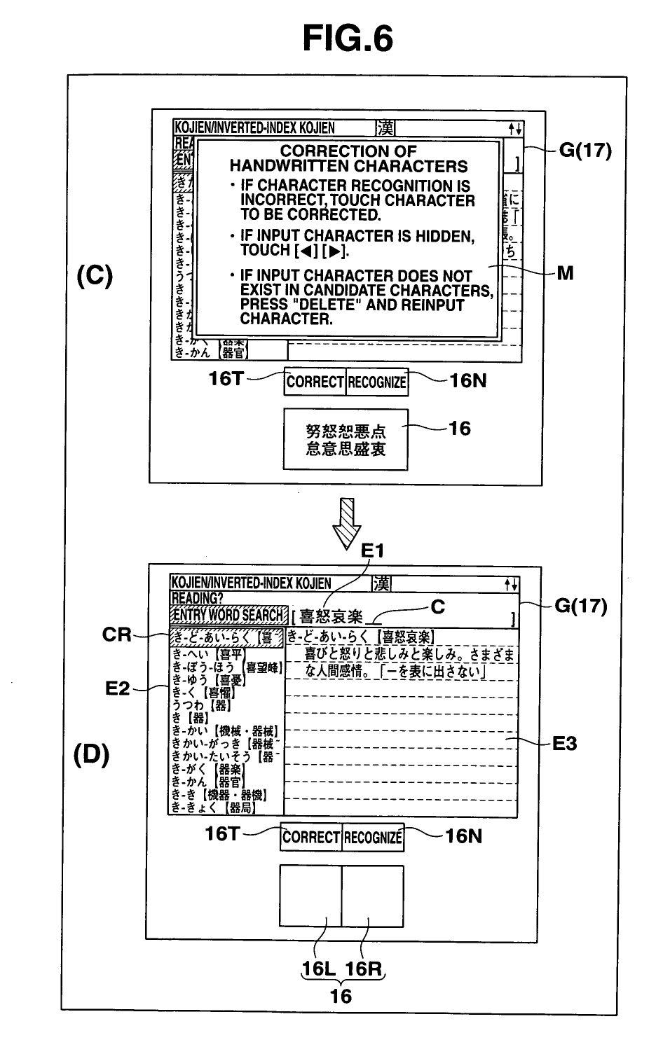

FIG. 6 is a drawing to help explain the dictionary search display operation (part 2) involved in the dictionary search process of the electronic dictionary device 10.

When a dictionary (Japanese-language dictionary) is specified by the dictionary specify key in the key input section 14, a dictionary search screen G (see FIG. 5(A)) having a search character input area E1 is displayed on the display section 17 and the electronic dictionary device 10 goes into a search character string (keyword) input waiting state (step S1). Then, when the user has performed a handwriting operation at the handwriting input section 16, the handwriting input process of FIG. 4 is carried out (step SA).

In the handwriting input process, when a touch operation accompanying the user handwriting input is sensed at the handwriting input section 16 (step A1), it is determined whether the sensed touch position has changed between the handwriting areas 16L and 16R, that is, whether the operation has proceeded to a handwriting input operation for the next character (step A2). As long as the time when the handwriting operation is carried out in either the handwriting area 16L or 16R, it is determined that the handwriting area has not changed (No in step A2), and the stroke corresponding to the touch position sensed in either writing area 16L (or 16R) is displayed (step A3→A1 to A3).

Then, when the user has finished writing one character in one area and begun to write the next character in the other area, it is determined that the touch position has moved between the areas 16L and 16R (Yes in step A2), the process of recognizing the handwritten character displayed in the handwriting area 16L (or 16R) at that time is carried out (step A5). When the user has touched “Recognize” button 16N after having finished writing one character in one area (Yes in step A4), control similarly proceeds to step A5, where the handwritten character recognizing process is carried out. The character recognition process can be performed using known techniques.

By the character recognition process, a plurality of characters similar to the handwritten character image are obtained as conversion candidates. Of the obtained candidate characters, a first candidate character with the highest degree of similarity is displayed as an input character in the position of cursor C in the search character input area E1 and stored in the search character string (keyword) memory 22g. Moreover, the first to tenth candidate characters are stored in the character recognition and conversion candidate buffer 22d (step A6). Then, the position of cursor C in the search character input area E1 is moved to the next position (step A7).

When the search character string (keyword) has been input to the search character input area E1 of the dictionary search screen G by handwriting input, the entry word which head-coincides with a series of search character strings (keywords) at that time is searched for on the basis of the user-specified dictionary data (22c) each time one character is input and is displayed in an entry word list area E2 (see FIG. 5(A)) (step S2).

Then, the dictionary content (explanatory information) corresponding to the entry word selected by an inverted cursor CR in the entry word list area E2 is read from the dictionary data (22c) and is displayed in the dictionary content display area E3 (step S3).

For example, FIG. 5(A) shows a state where the search character string [symbol] which has been input sequentially by handwriting and character-recognized in the processes of steps A1 to A7 in the handwriting input process is displayed in the search character input area E1. Then, the corresponding entry word list (E2) is displayed and the corresponding dictionary content (E3) is displayed.

If the user realizes in the middle that he or she has input an erroneous recognized character in the handwritten character recognizing process, the user corrects the error by using the “Correct” button 16T. For example, if [symbol] (the second character is incorrect) has been input as shown in FIG. 5(A) although [symbol] had to be input, when a touch operation of the “Correct” button 16T provided at the top left of the handwriting input section 16 is sensed (Yes in step A8), it is determined whether the search character string input in the search character input area E1 (22g) contains one character or plural characters (step A9).

Since the character string [symbol] in FIG. 5(A) contains four characters, it is determined that the character string is not composed of a single character (No in step A9) and the input character string [symbol] [symbol] is displayed as it is on the handwriting input section 16 (step A13). Simultaneously displayed on the handwriting input section 16 are a forward and a backward button 16F, 16B for scrolling a character string when the number of characters in the search character string is so large that they cannot be displayed in the area and “Confirm” button 16K for confirming the scrolled screen.

Then, when the specification of the second character [symbol] to be corrected is sensed in the search character string [symbol] displayed on the handwriting input section 16 (step A14), a first candidate character [symbol] to a tenth candidate character [symbol] stored in the character recognition and conversion candidate buffer 22d are displayed in list form for the specified character [symbol] to be corrected on the handwriting input section 16 as shown in FIG. 6(C) (step A10).

If it has been determined in step A9 that the search character string input and displayed in the search character input area E1 (22g) is a single character (Yes in step A9), the first candidate character to the tenth candidate character stored in the character recognition and conversion candidate buffer 22d are similarly displayed in list form for the search character string of the single character on the handwriting input section 16 (step A10).

Then, with a list of the individual candidate characters being displayed for the character [symbol] to be corrected on the handwriting input section 16 (see FIG. 6(C)), when a touch operation of selecting the candidate [symbol] to be input is sensed (Yes in step A11), the second character [symbol] to be corrected in the search character string [symbol] displayed in the search character input area E1 (22g) is replaced with the candidate character [symbol] selected by the touch operation, thereby displaying the corrected character string [symbol] (step A12).

Then, a dictionary search and display process is carried out according to the corrected search character string [symbol] . As a result, as shown in FIG. 6(D), each entry word from [symbol] is displayed in list form in the entry word list area E2 (step S2). At the same time, the dictionary content (explanatory information) corresponding to the entry word [symbol] is read into and displayed on the dictionary content display area E3 (step S3).

The character recognition and conversion candidate buffer 22d may be prevented from storing a first candidate characters and, when a list of recognized candidate characters is displayed, only a second and later candidate characters may be displayed.

During the time from when a touch operation of the “Correct” button 16T in the handwriting input section 16 is sensed in step A8 until a touch operation of selecting the candidate character to be input for each recognized candidate character displayed in list form on the handwriting input section 16 is sensed, a message window M on which a correction guide for the handwritten input character has been written is displayed on the dictionary search screen G displayed on the displayed section 17 as shown in FIG. 5(B) and FIG. 6(C).

On the other hand, for example, as shown in FIG. 6(C), if the candidate character to be input does not exist in the candidate character group displayed in list form on the handwriting input section 16, a “Delete” key is used. When an operation of the “Delete” key is sensed (Yes in step A15), the specified character to be corrected is deleted from the search character string displayed in the search character input area E1 (step A16). Then, a dictionary search and display process is carried out on the basis of the search character string from which the character to be corrected has been deleted (step S2), followed by the execution of a dictionary content display process (step S3). In this case, since the cursor C corresponding to the search character string in the search character input area E1 exists in the position of the character which was to be corrected this time and has been deleted, the user may input a new written character to the handwriting input section 16, thereby causing the character to be input to be recognized again and input.

Furthermore, in the processes of inputting, recognizing, and displaying handwritten characters in steps A1 to A7, when the user has used the “Delete” key without using the “Correct” button 17T, the operation of the “Delete” key is sensed (step A17) and the character input and recognized right before the operation and displayed in the search character input area E1 is deleted (step A18).

As described above, even if an erroneous character appears in the search character string (keyword) input after the handwritten character is recognized and input, the search character string including the erroneous character is displayed on the handwriting input section 16 by using the “Correct” button 17T. Then, the character to be corrected can be specified by simply touching the erroneous character in the search character string. Moreover, the recognized candidate characters for the specified character are displayed in list form on the handwriting input section 16. When the user touches the candidate character to be input in the list, the selected character is substituted for the erroneous character. Accordingly, the characters (character string) which have been written, recognized, and displayed can be corrected and displayed easily only by a handwriting input touch operation.

Moreover, if the correct character to be input does not exist in the recognized candidate characters displayed in list form on the handwriting input section 16, the specified character to be corrected can be replaced with the character character-recognize and selected as a recognized candidate character as a result of a handwritten character being input repeatedly at the handwriting input section 16. Then, the replaced character can be displayed.

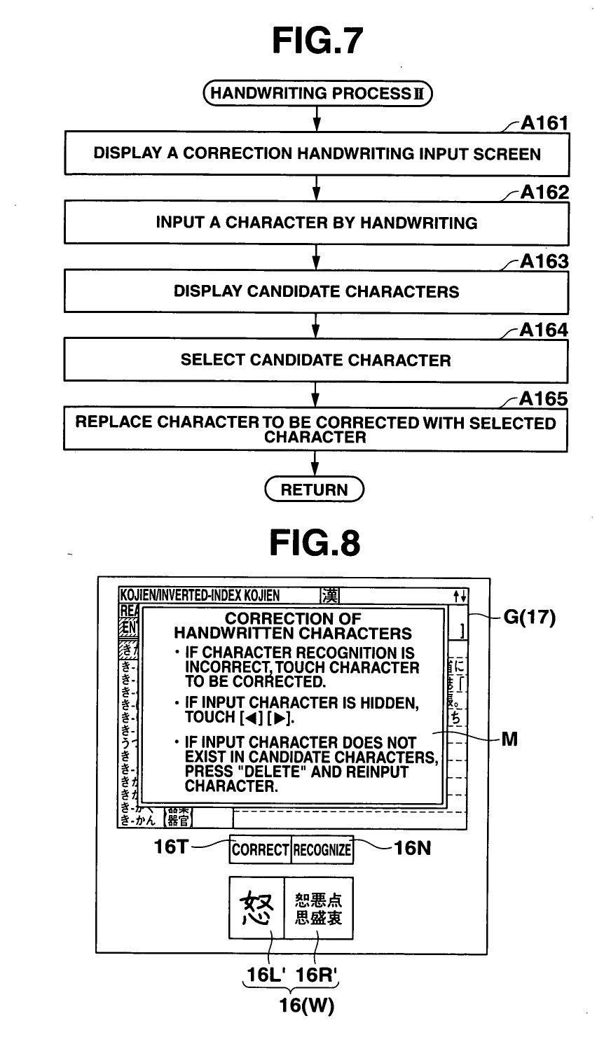

While in the handwriting input process of the embodiment (step SA), if the correct candidate character to be input does not exist in the individual recognized candidate characters corresponding to the specified character to be corrected and the operation of the “Delete” key has been sensed (Yes in step A15), the specified character to be corrected displayed in the search character input area E1 is deleted (step A16) and the correct character to be input is input again in the operation of inputting a new handwritten character to the handwriting input section 16 and is recognized and displayed, a second handwriting input process only for correction may be carried out after step A16. The second handwriting input process will be explained with reference to FIGS. 7 and 8.

FIG. 7 is a flowchart to help explain a second handwriting input process in the handwriting input process involved in the dictionary search process of the electronic dictionary device 10.

FIG. 8 is a drawing to help explain a handwriting input display operation in the handwriting input process involved in the dictionary search process of the electronic dictionary device 10.

Specifically, in step A10 in the handwriting input process of FIG. 4, for example, in a state where the individual recognized candidate characters corresponding to the specified character to be corrected are displayed in list form on the handwriting input section 16 as shown in FIG. 6(C), when the candidate character to be input does not exist in the individual recognized candidate characters and the input operation of the “Delete” key has been sensed (Yes in step A15), if the specified character to be corrected is deleted from a series of search character strings displayed in the search character input area E1 (step A16), the second handwriting input process of FIG. 7 is then started.

After the second handwriting input process is started, a correction handwriting input screen W is displayed where the left-side handwriting area of the handwriting input section 16 is a character handwriting area 16L′ and the right-side handwriting area 16R is a candidate character display area 16R′ as shown in FIG. 8 (step A161).

In the character handwriting area 16L′ of the correction handwriting input screen W, when a character to be input in place of the specified search character [symbol] to be corrected is input by a handwriting operation (step A162), the recognized candidate characters for the handwritten character input in the character handwriting area 16L′ are displayed in list form in the candidate character display area 16R′ (step A163).

Then, with a list of the individual candidate characters being displayed in the right-side candidate character display area 16R′ of the correction handwriting input screen W, when a touch operation of selecting the candidate character to be input is sensed (step A164), the character [symbol] to be corrected in the search character string [symbol] displayed in the search character input area E1 (22g) is replaced with the candidate character [symbol] written, recognized, and selected by the second handwriting input operation, thereby displaying the corrected character [symbol] (step A165).

Then, a dictionary search and display process is carried out according to the search character string [symbol] corrected only by the touch operation. As a result, as shown in FIG. 6(D), each entry word from [symbol] [symbol] is displayed in list form on the entry word list area E2 (step S2). At the same time, the dictionary content (explanatory information) corresponding to the entry word [symbol] specified by the inverted cursor CR is read into and displayed on the dictionary content display area E3 (step S3).

Accordingly, with the second handwriting input function in the handwriting input process involved in the dictionary search process of the electronic dictionary device 10, even if the correct character to be input does not exist in the recognized candidate characters displayed in list form on the handwriting input section 16 by the first handwriting input process of FIG. 4, the correction handwriting input screen W where the left side of the handwriting input section 16 is a character handwriting area 16L′ and the right side of the handwriting input section 16 is a candidate character display area 16R′ is displayed, and the specified character to be corrected can be replaced with the character character-recognized and selected as a recognized candidate character as a result of a handwritten character being input on the correction handwriting input screen W. Then, the replaced character can be displayed.

The handwritten character input and correcting function explained in the embodiment is not limited to the electronic dictionary device 10 and may be applied to a mobile terminal which includes not only a main display section (17) but also a handwriting input section (16) capable of echo back display, and to an electronic information device which has a character input function, such as a personal computer.

Moreover, any of the methods used in the processes carried out by the electronic dictionary device 10 of the embodiment, that is, the methods in the dictionary search process in the flowchart of FIG. 3, the handwriting input process involved in the dictionary search process in the flowchart of FIG. 4, and the second handwriting input process in the handwriting input process involved in the dictionary search process in the flowchart of FIG. 7, can be stored as a computer-executable program into an external storage medium 23, such as a memory card (e.g., a ROM card or a RAM card), a magnetic disk (e.g., a floppy disk or a hard disk), an optical disk (e.g., a CD-ROM or a DVD), or a semiconductor memory, and then can be distributed. Then, various computer terminals, which have not only a main display section (17) but also a handwriting input section (16) capable of echo back display, causes a storage medium reading section 24 to read the program stored in the external storage medium 23 into a memory 22. The operation of the computer terminal is controlled by the read-in program, thereby realizing the dictionary search and display function and the handwritten character input and correction display function explained in the embodiment, which enables the similar processes to be carried out by the above-described methods.

Furthermore, the data of the program to realize the above methods can be transferred in the form of program code over a communication network (Internet) N. The program data can be read from a computer terminal (program server) 20 connected to the communication network (Internet) N, thereby realizing the dictionary search and display function and the handwritten character input and correction display function.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A handwritten character input device comprising:
a display section;
a handwriting input section in which a touch position sensing unit and a display unit are integrated with each other;
character recognizing means for character-recognizing a character written on the handwriting input section;
recognized character display means for displaying as an input character a recognized character obtained at the character recognizing means;
correction character specifying means for specifying an input character to be corrected in an input character string displayed on the display section by the recognized character display means according to a touch operation performed by the user at the handwriting input section;
candidate character display means for displaying on the handwriting input section another recognized candidate character obtained at the character recognizing means for the input character to be corrected specified by the correction character specifying means; and
character correcting means for replacing the input character to be corrected displayed on the display section with the touched candidate character according to the operation of the user touching the candidate character displayed on the handwriting input section by the candidate character display means.

2. The handwritten character input device according to claim 1, wherein the correction character specifying means includes input character display control means for displaying on the handwriting input section an input character string displayed on the display section, and the user specifies an input character to be corrected by touching an input character displayed on the handwriting input section by the input character display control means.

3. The handwritten character input device according to claim 1, further comprising: control means for, when the user does not touch another recognized candidate character displayed on the handwriting input section by the candidate character display means, causing the character recognizing means to recognize a new handwritten character on the handwriting input section and correct the input character to be corrected displayed on the display section.

4. The handwritten character input device according to claim 1, further comprising: a second character correcting means for setting a handwritten character input area and a candidate character display area in the handwriting input section after the candidate character display means displays another recognized candidate character obtained at the character recognizing means on the handwriting input section, and for replacing the input character to be corrected displayed on the display section with a character corresponding to a character written in the handwritten character input area and displayed as a recognized candidate character in the candidate character display area.

5. A handwritten character input method in a handwritten character input device which includes a display section and a handwriting input section where a touch position sensing unit and a display unit are integrated with each other, the handwritten character input method comprising:
a character recognizing step of character-recognizing a character written on the handwriting input section;
a recognized character display step of displaying as an input character a recognized character obtained in the character recognizing step;
a correction character specifying step of specifying an input character to be corrected in an input character string displayed on the display section in the recognized character display step according to a touch operation performed by the user at the handwriting input section;
a candidate character display step of displaying on the handwriting input section another recognized candidate character obtained in the character recognizing step for the input character to be corrected specified in the correction character specifying step; and
a character correcting step of replacing the input character to be corrected displayed on the display section with the touched candidate character according to the operation of the user touching the candidate character displayed on the handwriting input section in the candidate character display step.

6. The handwritten character input method according to claim 5, wherein the correction character specifying step includes an input character display control step of displaying on the handwriting input section an input character string displayed on the display section, and the user specifies an input character to be corrected by touching an input character displayed on the handwriting input section in the input character display control step.

7. The handwritten character input method according to claim 5, further comprising: a control step of, when the user does not touch another recognized candidate character displayed on the handwriting input section in the candidate character display step, causing the character recognizing step to recognize a new handwritten character on the handwriting input section and correct the input character to be corrected displayed on the display section.

8. The handwritten character input method according to claim 5, further comprising: a second character correcting step of setting a handwritten character input area and a candidate character display area in the handwriting input section after the candidate character display step displays another recognized candidate character obtained in the character recognizing step on the handwriting input section, and of replacing the input character to be corrected displayed on the display section with a character corresponding to a character written in the handwritten character input area and displayed as a recognized candidate character in the candidate character display area.
